(19) United States
(12) Patent Application Publication
(10) Pub. No.: US 2007/0141237 A1
(43) Pub. Date: Jun. 21, 2007

(54) Method for producing membrane-electrode assembly for fuel cell

(76) Inventors: Gen Okiyama, Sayama-shi, Saitama (JP); Tomoko Date, Sayama-shi, Saitama (JP); Yasuhiro Nakao, Sayama-shi, Saitama (JP); Osamu Kakutani, Sayama-shi, Saitama (JP)

Correspondence Address: RANKIN, HILL, PORTER & CLARK LLP, 4080 ERIE STREET, WILLOUGHBY, OH, 44094-7836, US

(21) Appl. No.: 10/595,454

(22) PCT Filed: Sep. 15, 2004
(86) PCT No.: PCT/JP04/13882

§ 371 Date: Apr. 20, 2006

(30) Foreign Application Priority Data
Oct. 22, 2003 (JP) JP 2003-362017

(51) Int. Cl. B05D 5/12; H01M 4/88

(52) U.S. Cl. 427/115; 502/101

(57) ABSTRACT

Disclosed is a method for removing a solvent (41) in an electrolyte membrane (24) as a constituent of a membrane-electrode assembly (12) used in a fuel cell. The membrane-electrode assembly is arranged in a water vapor, and the water vapor is introduced into the electrolyte membrane by being transmitted through diffusion layers (21, 27) respectively on positive/negative electrode sides. The solvent in the electrolyte membrane is removed by the thus-introduced water vapor. This removal of the solvent is performed at temperatures which are not higher than the decomposition temperature of the hydrocarbon solid polymer.

### TECHNICAL FIELD

The present invention relates to a method of producing an electrode-membrane assembly used in a fuel cell and more particularly to a method of producing an electrode-membrane assembly having an electrolyte membrane of a hydrocarbon solid polymer.

### BACKGROUND ART

FIG. 11 shows a known electrode-membrane assembly for a fuel cell.

Referring to FIG. 11, the electrode-membrane assembly 100 comprises a negative electrode diffusion layer 101, a negative electrode substrate layer 102 laid on the negative electrode diffusion layer 101, a negative electrode layer 103 laid on the negative electrode substrate layer 102, an electrolyte membrane 104 laid on the negative electrode layer 103, a positive electrode layer 105 laid on the electrolyte membrane 104, a positive electrode substrate layer 106 laid on the positive electrode layer 105 and a positive electrode diffusion layer 107 laid on the positive electrode substrate layer 106.

A method of removing a coating organic solvent from the positive and negative electrode layers 105 and 103 when making the electrode-membrane assembly 100 in order to improve the power generating performance of the electrode-membrane assembly 100 is disclosed in, for example, JP-A-9-274924. This method of producing an electrode-membrane assembly will be described substrated on (a) to (f) of FIG. 12.

In FIG. 12 (a), a negative electrode diffusion layer 101 is coated with a negative electrode layer 103 in varnish form to form a negative electrode laminate 108.

The electrode layer 103 in varnish form is a varnish made by mixing an electrode catalyst, etc. in a coating organic solvent.

In (b), water 109 is boiled to form a water vapor stream a1 and the water vapor stream a1 removes the coating organic solvent from the electrode layer 103 in varnish form as shown by arrows b1.

In (c), a positive electrode diffusion layer 107 is coated with a positive electrode layer 105 in varnish form to form a positive electrode laminate 110.

The electrode layer 105 in varnish form is a varnish made by mixing an electrode catalyst, etc. in a coating organic solvent.

In (d), water 109 is boiled to form a water vapor stream a1 and the water vapor stream a1 removes the coating organic solvent from the electrode layer 105 in varnish form as shown by arrows b1.

In (e), an electrolyte membrane 104 is disposed between the negative electrode laminate 108 and the positive electrode laminate 110.

In (f), the positive and negative electrode laminates 110 and 108 having the electrolyte membrane 104 disposed therebetween are hot pressed together.

The positive and negative electrode laminates 110 and 108 and the electrolyte membrane 104 are thereby joined together to form an electrode-membrane assembly 100.

The electrode-membrane assembly 100 has its power generating performance improved by removing the coating organic solvents from the positive and negative electrode layers 105 and 103 when it is produced.

When an electrolyte membrane 104 is formed, however, a coating organic solvent 111 is mixed with a solid polymer to form a varnish like the positive and negative electrode layers 105 and 103. The electrolyte membrane 104 in varnish form is shaped into a sheet and disposed between the positive and negative electrode laminates 110 and 108. Therefore, the electrode-membrane assembly 100 contains the coating organic solvent 111 in the electrolyte membrane 104 and this has been a factor injuring the power generating performance of the electrode-membrane assembly 100.

A method in which a prolonged hot pressing time or an elevated pressure is employed for hot pressing the electrolyte membrane 104 between the positive and negative electrode laminates 110 and 108 may be adopted as a method for removing the coating organic solvent 111 from the electrolyte membrane 104. The prolongation of the hot pressing time for the electrode-membrane assembly 100 makes it possible to remove the coating organic solvent 111 from the electrolyte membrane 104.

However, the prolongation of the hot pressing time makes it difficult to raise the productivity of the electrode-membrane assembly 100.

The elevation of the pressure for hot pressing the electrode-membrane assembly 100 makes it possible to remove the coating organic solvent 111 from the electrolyte membrane 104.

However, the excessive elevation of the pressure for the electrode-membrane assembly 100 is likely to cause the compression of the positive and negative electrode layers 105 and 103. The compression of the positive and negative electrode layers 105 and 103 makes it difficult to raise the power generating performance of the electrode-membrane assembly 100.

Thus, there is desired technique making it possible to raise the power generating performance of an electrode-membrane assembly for a fuel cell, while maintaining its productivity.

### DISCLOSURE OF THE INVENTION

According to the present invention, there is provided a method of producing an electrode-membrane assembly for a fuel cell by coating one of positive and negative electrode diffusion layers with a substrate layer, coating the substrate layer with one of positive and negative electrode layers before the drying of the substrate layer, coating the electrode layer with a hydrocarbon solid polymer with a solvent added thereto before the drying of the electrode layer to form an electrolyte membrane, coating the electrolyte membrane with the other of the positive and negative electrode layers before the drying of the electrolyte membrane and superposing on the other electrode layer before the drying of the other electrode layer a two-layer body formed by coating the other of the positive and negative electrode diffusion layers with a substrate layer to produce an electrode-membrane assembly, which method comprises the steps of: preliminarily drying the electrode-membrane assembly in its non-dry state at a temperature not exceeding the decomposition temperature of the hydrocarbon solid polymer, placing the preliminarily dried electrode-membrane assembly in vapor to introduce vapor into the electrolyte membrane, removing the solvent from the electrolyte membrane with the vapor introduced thereinto, and drying finally the electrode-membrane assembly having the solvent removed from the electrolyte membrane at a temperature not exceeding the decomposition temperature of the hydrocarbon solid polymer.

The immersion of the electrode-membrane assembly in a water tank to introduce water into the electrolyte membrane and thereby cause the solvent to flow out from the electrolyte membrane may occur as a method of removing the solvent from the electrolyte membrane. However, the positive and negative electrode diffusion layers forming the opposite sides of the electrode-membrane assembly are water-repellent and are sparingly permeable to water in a liquid state. Even if the electrode-membrane assembly may be immersed in a water tank, therefore, the positive and negative electrode diffusion layers prevent water in a liquid state from entering the electrolyte membrane and make it difficult to remove the solvent from the electrolyte membrane.

The positive and negative electrode diffusion layers prevent the permeation of water in a liquid state, but do not prevent the permeation of water vapor. Generally, a gas is composed of molecules occurring individually, but a liquid is composed of molecules gathering in a several tens of to several thousand times larger volume and has an apparent particle diameter which is drastically larger than that of a gas. As the pores of the positive and negative electrode diffusion layers are larger in diameter than gases, and smaller than liquids, the positive and negative electrode diffusion layers prevent the permeation of water in a liquid state, but do not prevent the permeation of water vapor.

In this invention, therefore, the electrode-membrane assembly is placed in vapor (water vapor) to introduce vapor into the electrolyte membrane and remove the solvent from the electrolyte membrane with the vapor introduced thereinto.

When vapor is used for the removal of the solvent as stated, vapor passes through the positive and negative electrode diffusion layers and is introduced into the electrolyte membrane. The vapor introduced into the electrolyte membrane makes it possible to remove the solvent from the electrolyte membrane smoothly. Accordingly, the electrode-membrane assembly has an elevated power generating performance, while maintaining its productivity.

Preferably, the removal of the solvent from the electrolyte membrane is performed at a temperature not exceeding the decomposition temperature of the hydrocarbon solid polymer.

The elevation of saturation vapor pressure is preferable for vapor (water vapor) to remove the solvent from the electrolyte membrane satisfactorily. The elevation of the saturation vapor pressure makes it necessary to maintain at a high level the temperature of the environment in which vapor treatment is performed. However, if the environment temperature is higher than the decomposition temperature of the hydrocarbon solid polymer, the hydrocarbon solid polymer is decomposed. Therefore, the removal of the solvent from the electrolyte membrane is performed at a temperature not exceeding the decomposition temperature of the hydrocarbon solid polymer. This makes it possible to remove the solvent from the electrolyte membrane without having the hydrocarbon solid polymer decomposed and thereby raise the power generating performance of the electrode-membrane assembly.

It is preferable that the removal of the solvent from the electrolyte membrane is performed by applying no load or a load of 1.5 kPa or less to the electrode-membrane assembly in its state before drying, and the final drying of the electrode-membrane assembly is performed by applying no load or a load of 1.5 kPa to the electrode-membrane assembly having the solvent removed from the electrolyte membrane.

A plurality of electrode-membrane assemblies is stacked on one another and a specific assembling load is applied to the stacked electrode-membrane assemblies to assemble a fuel cell unit. When power is generated by the fuel cell unit, the electrolyte membrane and the positive and negative electrode layers expand or contract. Therefore, the assembling load applied to the stacked electrode-membrane assemblies is restricted to a relatively low level to make the electrolyte membrane and the positive and negative electrode layers movable upon expansion or contraction so that their expansion or contraction may be absorbed.

Incidentally, it is possible that when the solvent is removed from the electrolyte membrane with vapor, the vapor may penetrate into the electrolyte membrane and the positive and negative electrodes and cause them to expand. When the electrode-membrane assembly is finally dried, on the other hand, it is possible that the removal of the solvent from the electrolyte membrane and the positive and negative electrodes may cause the electrolyte membrane, etc. to contract. Accordingly, it is possible that the treatment for removing the solvent from the electrolyte membrane and the final drying of the electrode-membrane assembly may place the electrolyte membrane and the positive and negative electrode layers in substantially the same state as when power is generated by the fuel cell unit.

Thus, it is likely to follow that if a load which is higher than the load for assembling the fuel cell unit is applied for the treatment for removing the solvent from the electrolyte membrane and the final drying of the electrode-membrane assembly, those portions of the electrolyte membrane and the positive and negative electrode layers to which the load has been applied may be pressed strongly and become immovable. If the strongly pressed portions become immovable, the electrolyte membrane and the positive and negative electrode layers expand or contract. As a result, it is likely that the electrolyte membrane and the positive and negative electrode layers may be separated.

Therefore, the removal of the solvent from the electrolyte membrane may be performed by applying no load or a relatively low load of 1.5 kPa or less to the electrode-membrane assembly in its non-dry state, as stated above. This makes the electrolyte membrane and the positive and negative electrode layers movable to absorb expansion when vapor penetrates into the electrolyte membrane and the positive and negative electrode layers and causes them to expand on the occasion of the treatment for the removal of the solvent from the electrolyte membrane.

Moreover, the final drying may also be performed by applying no load or a relatively low load of 1.5 kPa or less to the electrode-membrane assembly having the solvent removed from the electrolyte membrane. This makes the electrolyte membrane and the positive and negative electrode layers movable to absorb contraction when the removal of the solvent causes the electrolyte membrane and the positive and negative electrode layers to contract on the occasion of the final drying.

The absorption of expansion or contraction of the electrode membrane and the positive and negative electrode layers prevents the separation or cracking of the electrode membrane and the positive and negative electrode layers.

The solvent used in the method of the present invention is preferably at least one selected from N-methyl-2-pyrrolidone, dimethylacetamide, dimethyl sulfoxide, N,N-dimethylformamide and γ-butyrolactone. These solvents are suitable for the mass production of electrolyte membranes, as they are relatively easily available.

These solvents have a higher boiling point than that of water. However, the solvent in the electrolyte membrane can be removed properly by the vapor introduced into the electrolyte membrane, even if the solvent temperature may not be raised to its boiling point. Therefore, they are easy to use as the solvent for the electrolyte membrane.

### BRIEF DESCRIPTION OF THE DRAWINGS

FIG. 1 is an exploded perspective view showing a fuel cell unit including an electrode-membrane assembly according to the present invention.

FIG. 2 is a diagram showing the structure of the electrode-membrane assembly shown in FIG. 1.

FIGS. 3A and 3B are diagrams showing an example in which the electrode-membrane assembly is preliminarily dried.

FIGS. 4A and 4B are diagrams showing an example in which vapor is introduced into the electrode-membrane assembly.

FIGS. 5A and 5B are diagrams showing an example in which vapor is introduced into the electrolyte membrane in the electrode-membrane assembly.

FIGS. 6A, 6B and 6C are diagrams showing an example in which the electrode-membrane assembly is finally dried.

FIGS. 7A and 7B are diagrams showing a comparative example in which a solvent is removed from the electrolyte membrane by immersing the electrode-membrane assembly in water.

FIGS. 8A and 8B are graphs comparing a comparative example and an example of the invention with respect to the time required for the removal of the solvent from the electrolyte membrane and the remaining amount of the solvent.

FIGS. 9A and 9B are diagrams showing an example in which the electrode-membrane assembly of the present invention is employed as a fuel cell.

FIGS. 10A and 10B are diagrams showing an example in which the electrode-membrane assembly according to the comparative example is employed as a fuel cell.

FIG. 11 is a diagram showing the structure of a known electrode-membrane assembly for a fuel cell.

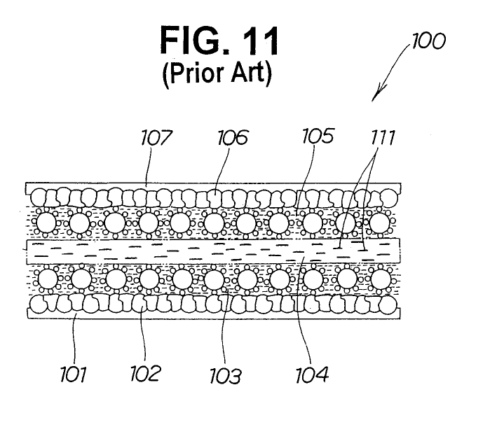

FIGS. 12(a) to (f) are diagrams showing a method of producing the known electrode-membrane assembly.

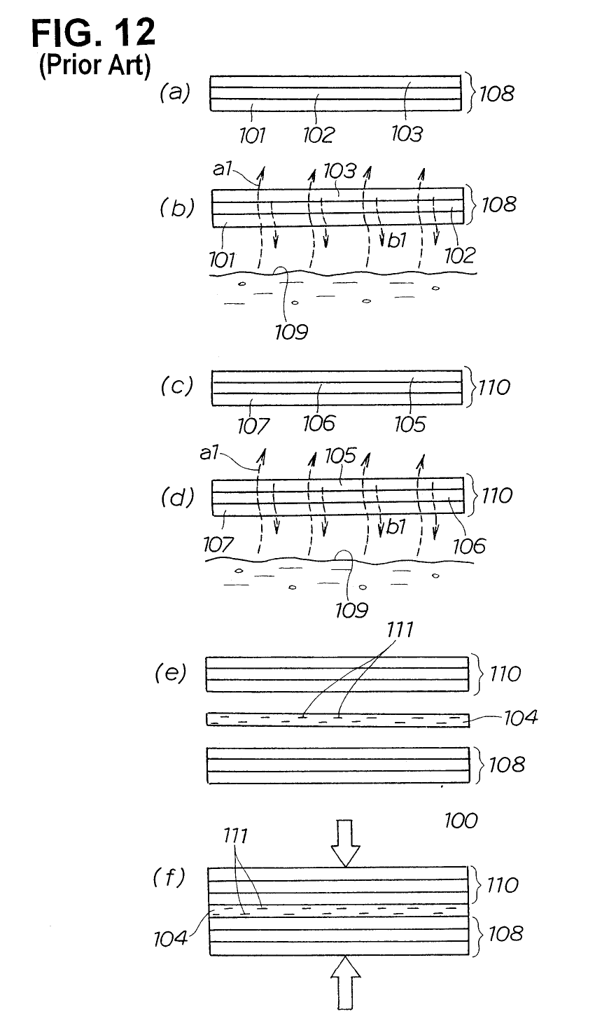

### BEST MODE FOR CARRYING OUT THE INVENTION

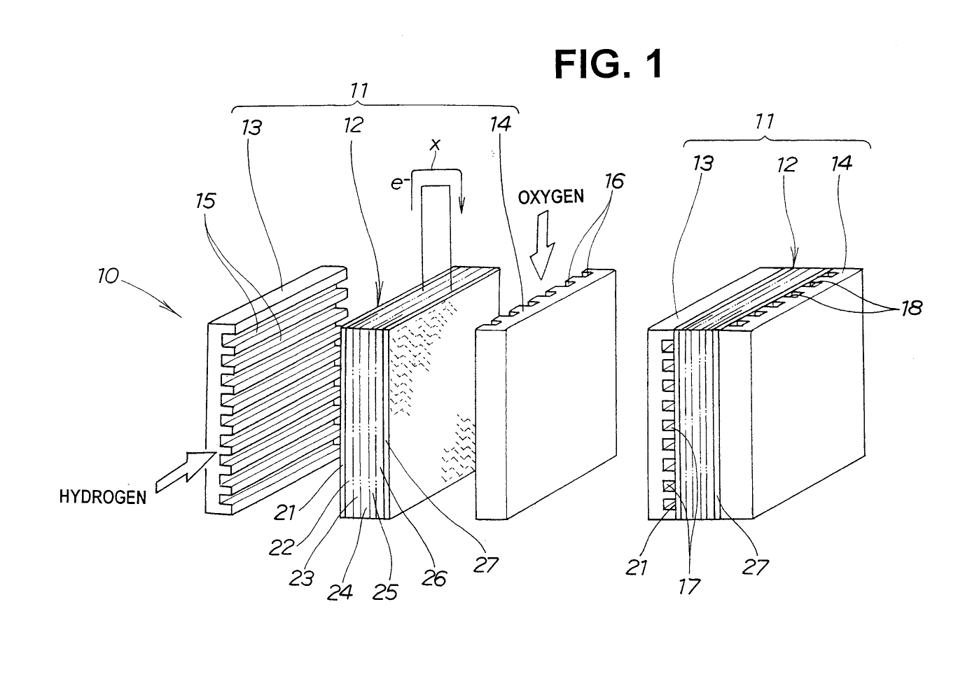

FIG. 1 shows a fuel cell unit 10 including an electrode-membrane assembly for a fuel cell according to the present invention.

The fuel cell unit 10 is composed of a plurality of fuel cells 11 (two in the example shown in FIG. 1).

Each fuel cell 11 has a negative electrode separator 13 and a positive electrode separator 14 on the opposite sides, respectively, of an electrode-membrane assembly 12 for a fuel cell.

The electrode-membrane assembly 12 is composed of a negative electrode diffusion layer 21, a negative electrode substrate layer 22, a negative electrode layer 23, an electrolyte membrane 24, a positive electrode layer 25, a positive electrode substrate layer 26 and a positive electrode diffusion layer 27 superposed on one another.

The negative electrode diffusion layer 21 and the positive electrode diffusion layer 27 define the opposite sides of the electrode-membrane assembly 12.

The negative electrode separator 13 is superposed on the negative electrode diffusion layer 21. A plurality of passage grooves 15 formed in the negative electrode separator 13 are covered by the negative electrode diffusion layer 21 and the negative electrode diffusion layer 21 and the passage grooves 15 define a plurality of hydrogen gas passages 17.

The positive electrode separator 14 is superposed on the positive electrode diffusion layer 27. A plurality of passage grooves 16 formed in the positive electrode separator 14 are covered by the positive electrode diffusion layer 27 and the positive electrode diffusion layer 27 and the passage grooves 16 define a plurality of oxygen gas passages 18.

According to the fuel cell 11, electrons (e⁻) flow as shown by an arrow x to produce an electric current when the hydrogen gas passages 17 are fed with hydrogen gas, while the oxygen gas passages 18 are fed with oxygen gas.

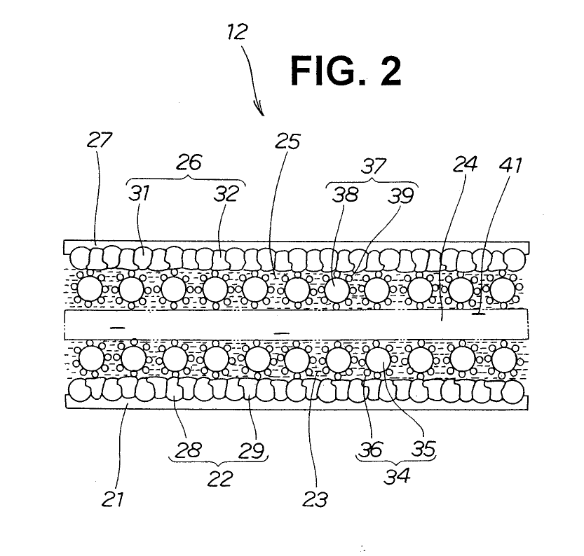

FIG. 2 shows the electrode-membrane assembly 12 for a fuel cell according to the present invention.

The electrode-membrane assembly 12 is composed of a negative electrode diffusion layer 21, a negative electrode substrate layer 22 superposed on the negative electrode diffusion layer 21, a negative electrode layer 23 superposed on the negative electrode substrate layer 22, an electrolyte membrane 24 superposed on the negative electrode layer 23, a positive electrode layer 25 superposed on the electrolyte membrane 24, a positive electrode substrate layer 26 superposed on the positive electrode layer 25 and a positive electrode diffusion layer 27 superposed on the positive electrode substrate layer 26.

The negative electrode diffusion layer 21 and the positive electrode diffusion layer 27 are formed from, fro example, porous carbon paper to which water-repelling treatment has been given.

The negative electrode diffusion layer 21 is so constructed by its water-repelling treatment that water is repelled by its surface and is hardly permeable through the negative electrode diffusion layer 21 when water is in a liquid state, while it is easily permeable when water is in a gaseous state (water vapor).

The positive electrode diffusion layer 27 is so constructed by its water-repelling treatment like the negative electrode diffusion layer 21 that water is repelled by its surface and is hardly permeable through the positive electrode diffusion layer 27 when water is in a liquid state, while it is easily permeable when water is in a gaseous state (water vapor).

Generally, a gas is composed of molecules occurring individually, but a liquid is composed of molecules gathering in a several tens of to several thousand times larger volume and has an apparent particle diameter which is drastically larger than that of a gas.

As the water-repelling treatment of the positive and negative electrode diffusion layers 21 and 27 makes the pores of the positive and negative electrode diffusion layers 21 and 27 larger in diameter than gases, but smaller than liquids, the positive and negative electrode diffusion layers 21 and 27 prevent the permeation of water in a liquid state, but do not prevent the permeation of water vapor.

The negative electrode substrate layer 22 is formed from, for example, granular carbon 28 and a binder (fluororesin) 29 added thereto.

The positive electrode substrate layer 26 is formed from, for example, granular carbon 31 and a binder (having sulfonic acid introduced into the skeleton of polytetrafluoroethylene) 32 added thereto.

The negative electrode layer 23 is formed by coating the negative electrode substrate layer 22 with a mixture of a catalyst (electrode grains) 34 and a solvent for the negative electrode and solidifying it by drying the solvent. The catalyst 34 in the negative electrode layer 23 has a platinum-ruthenium alloy 36 supported as a catalyst on the surface of carbon 35.

The positive electrode layer 25 is formed by coating the electrolyte membrane 24 with a mixture of a catalyst (electrode grains) 37 and a solvent for the positive electrode and solidifying it by drying the solvent. The catalyst 37 in the positive electrode layer 25 has platinum 39 supported as a catalyst on the surface of carbon 38.

The electrolyte membrane 24 is formed as an integrally solidified part of the negative electrode layer 23 and the positive electrode layer 25 by coating the negative electrode layer 23 with a varnish prepared by adding a solvent 41 to a hydrocarbon solid polymer and removing and solidifying the solvent. The hydrocarbon solid polymer has a decomposition temperature of 160° C. to 200° C.

The solvent 41 is at least one selected from among NMP (N-methyl-2-pyrrolidone), DMAc (dimethylacetamide), DMSO (dimethyl sulfoxide), DMF (N,N-dimethylformamide) and γ-butyrolactone.

NMP (N-methyl-2-pyrrolidone), DMAc (dimethylacetamide), DMSO (dimethyl sulfoxide), DMF (N,N-dimethylformamide) and γ-butyrolactone are relatively easily available and are easy to use as the solvent for the electrolyte membrane 24.

NMP (N-methyl-2-pyrrolidone) is a solvent having a boiling point of 204° C.

DMAc (dimethylacetamide) is a solvent having a boiling point of 165.5° C.

DMSO (dimethyl sulfoxide) is a solvent having a boiling point of 189° C.

DMF (N,N-dimethylformamide) is a solvent having a boiling point of 153° C.

γ-butyrolactone is a solvent having a boiling point of 204° C.

Thus, the solvent 41 has a boiling point which is higher than the decomposition temperature of 160° C. to 200° C. of the hydrocarbon solid polymer.

The solvents 41 include a solvent having a boiling point which is lower than the decomposition temperature of 160° C. to 200° C. of the hydrocarbon solid polymer, like DMF (N,N-dimethylformamide) having a boiling point of 153° C., and reference will later be made to the use of a solvent 41 having a boiling point which is lower than the decomposition temperature of 160° C. to 200° C. of the hydrocarbon solid polymer.

If a solvent 41 having a boiling point higher than the decomposition temperature of 160° C. to 200° C. of the hydrocarbon solid polymer is used, it is difficult to raise the drying temperature to the boiling point of the solvent 41 when drying the laminated electrode-membrane assembly 12 and thereby remove the solvent 41 from the electrolyte membrane 24.

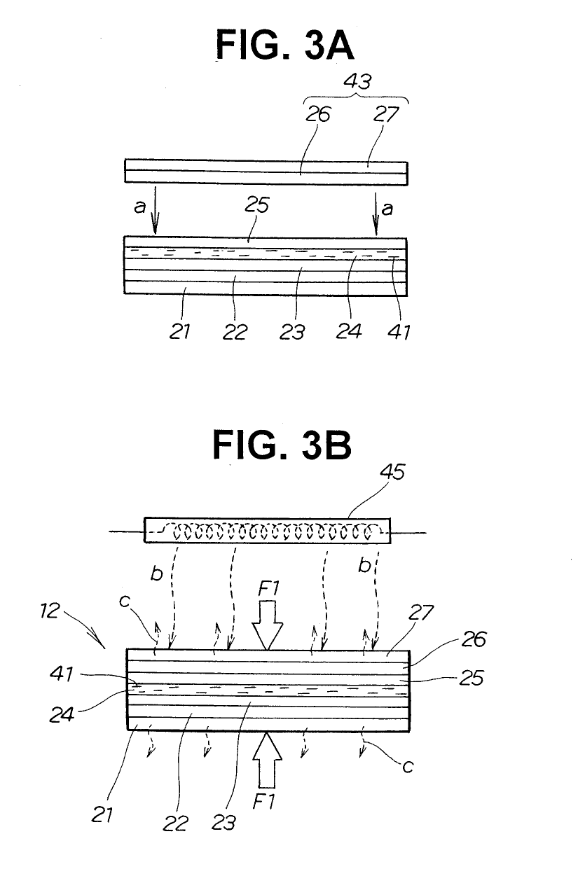

The method of the present invention for removing the solvent 41 remaining in the electrolyte membrane 24 in the method of producing the electrode-membrane assembly 12 will now be described based on FIGS. 3A to 6C.

FIGS. 3A and 3B show an example in which the electrode-membrane assembly for a fuel cell is preliminarily dried.

In FIG. 3A, a negative electrode diffusion layer 21 is coated with a negative electrode substrate layer 22 and before the negative electrode substrate layer 22 dries, it is coated with a negative electrode layer 23.

Before the negative electrode layer 23 dries, a hydro-carbon solid polymer to which at least one solvent 41 selected from N-methyl-2-pyrrolidone, dimethylacetamide, dimethyl sulfoxide, N,N-dimethylformamide and γ-butyrolactone has been added is applied to coat the negative electrode layer 23 to form an electrolyte membrane 24.

Then, the electrolyte membrane 24 is coated with a positive electrode layer 25 before it dries.

Finally, a two-layer body 43 made by coating a positive electrode diffusion layer 27 with a positive electrode substrate layer 26 is superposed on the positive electrode layer 25 as shown by arrows a before the positive electrode layer 25 dries, whereby an electrode-membrane assembly 12 in its non-dry state is obtained.

In FIG. 3B, a load F1 is applied to the electrode-membrane assembly 12 in its non-dry state and it is heated by a heater 45 as shown by arrows b. Its heating temperature is set at a temperature not exceeding the decomposition temperature of the hydrocarbon solid polymer. More specifically, the decomposition temperature of the hydrocarbon solid polymer is from 160° C. to 200° C. and the heating temperature is from 50° C. to 150° C.

The heating of the electrode-membrane assembly 12 in its non-dry state by the heater 45 performs its preliminary drying by causing a part of the solvent to evaporate from the electrode-membrane assembly 12 in its non-dry state as shown by arrows c.

The electrode-membrane assembly 12 in its non-dry state is held under no load, or a relatively low load F1 of 1.5 kPa or less. Accordingly, the electrolyte membrane 24, negative electrode layer 23 and positive electrode layer 25 are freely movable when they contract as a result of the evaporation of a part of the solvent from the electrode-membrane assembly 12 in its non-dry state as shown by the arrows C.

Under no load or only a limited load F1 of 1.5 kPa or less as stated, the absorption of contraction of the electrolyte membrane 24, negative electrode layer 23 and positive electrode layer 25 prevents the separation or cracking of the electrolyte membrane 24, negative electrode layer 23 and positive electrode layer 25.

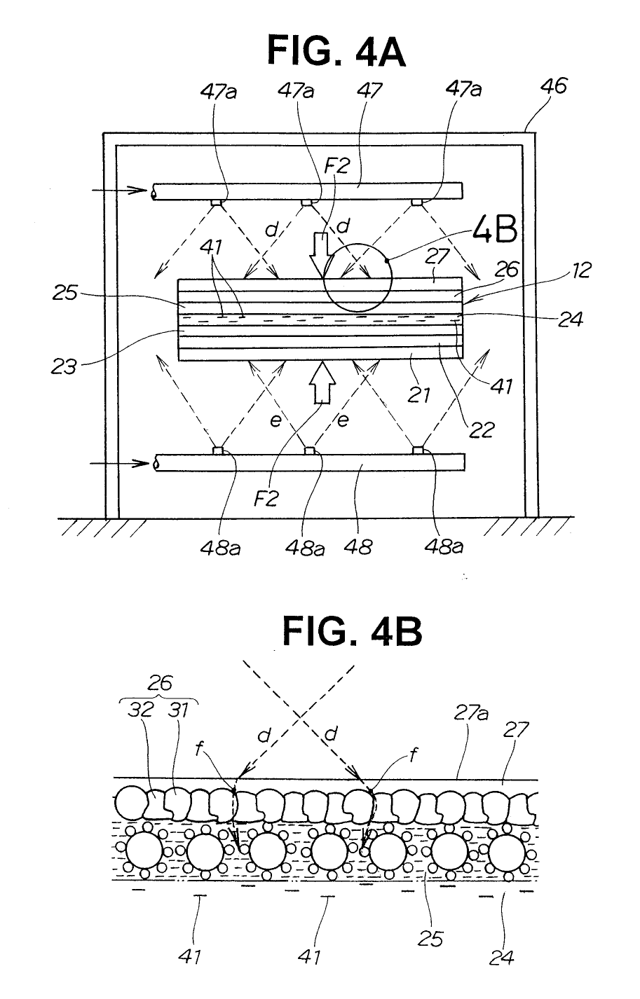

FIGS. 4A and 4B show an example in which vapor is introduced into the electrode-membrane assembly.

In FIG. 4A, the preliminarily dried electrode-membrane assembly 12 is placed in its treating position in a vapor treatment chamber 46, i.e. between an upper vapor spray device 47 and a lower vapor spray device 48.

After its placement, a load F2 is applied to the electrode-membrane assembly 12 in its preliminarily dried state. Then, a plurality of nozzles 47a of the upper vapor spray device 47 spray vapor (water vapor) against the preliminarily dried electrode-membrane assembly 12 as shown by arrows d.

At the same time, a plurality of nozzles 48a of the lower vapor spray device 48 spray vapor (water vapor) against the preliminarily dried electrode-membrane assembly 12 as shown by arrows e.

The vapor treatment chamber 46 maintains an atmosphere having a high temperature not exceeding the decomposition temperature of 160° C. to 200° C. of the hydrocarbon solid polymer, or more specifically from 70° C. to 150° C.

Vapor reaches the surface 27a of the positive electrode diffusion layer 27 as shown by the arrows d in FIG. 4B. The positive electrode diffusion layer 27 has water repellency. Accordingly, water in a liquid state is repelled by the surface 27a of the positive electrode diffusion layer 27 and cannot pass through the positive electrode diffusion layer 27. However, water in the form of individual molecules produced by vapor (referred to simply as “vapor” for convenience of explanation) can pass through the positive electrode diffusion layer 27. Thus, vapor sprayed from the nozzles 47a passes from the surface of the positive electrode diffusion layer 27 into the positive electrode diffusion layer 27 as shown by arrows f.

The vapor which has passed into the positive electrode diffusion layer 27 passes from the positive electrode diffusion layer 27 into the positive electrode substrate layer 26 and the positive electrode layer 25.

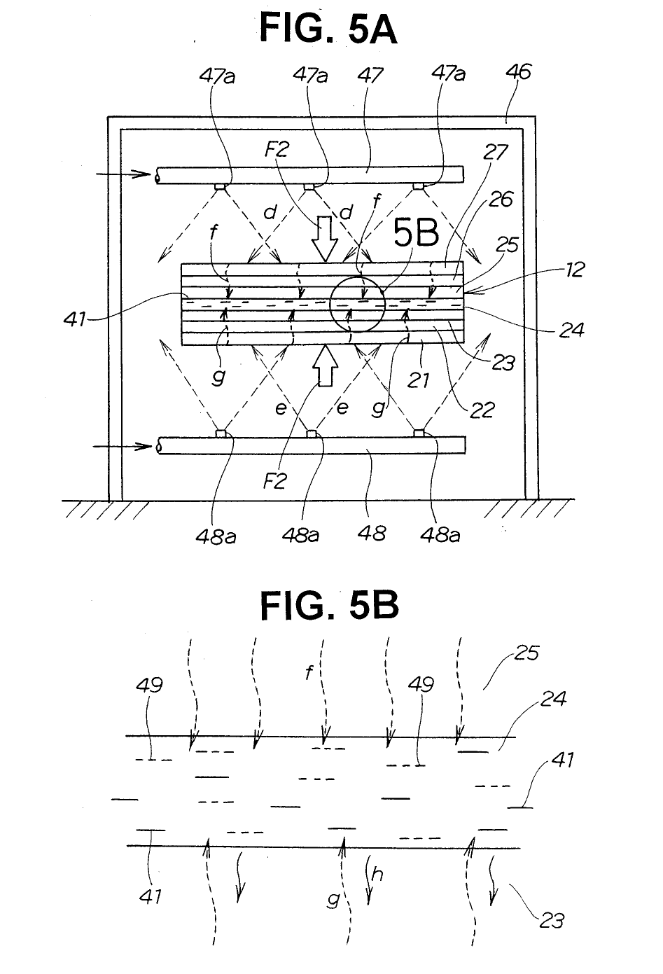

FIGS. 5A and 5B show an example in which vapor is introduced into the electrolyte membrane 24 in the electrode-membrane assembly 12.

In FIG. 5A, the vapor which has passed through the positive electrode diffusion layer 27 passes through the positive electrode substrate layer 26 and the positive electrode layer 25 and reaches the electrolyte membrane 24, as shown by arrows f.

Likewise, vapor sprayed from the nozzles 48a of the lower vapor spray device 48 as shown by arrows e passes through the negative electrode diffusion layer 21. The vapor which has passed through the negative electrode diffusion layer 21 passes through the negative electrode substrate layer 22 and the negative electrode layer 23 and reaches the electrolyte membrane 24, as shown by arrows g.

The vapor which has reached the electrolyte membrane 24 as shown by the arrows f and g enters the electrolyte membrane 24, as shown in FIG. 5B.

The vapor introduced into the electrolyte membrane 24 as described dispels the solvent 41 from the electrolyte membrane 24 as shown by arrows h. The vapor which has entered the electrolyte membrane 24 remains as water 49 in the electrolyte membrane 24.

A good state of water vapor is maintained by performing the treatment for solvent removal by vapor at a high temperature of 70° C. to 150° C., as shown in FIG. 5A. It makes it possible to introduce vapor smoothly into the electrolyte membrane 24 and thereby remove the solvent 41 from the electrolyte membrane 24 in a shorter time. It is, however, necessary to hold a temperature which is lower than the decomposition temperature of 160° C. to 200° C. of the hydrocarbon solid polymer.

The treatment for solvent removal by vapor is performed at a temperature not exceeding the decomposition temperature of 160° C. to 200° C. of the hydrocarbon solid polymer forming the electrolyte membrane 24, as stated above. This makes it possible to remove the solvent from the electrolyte membrane 24 without having the hydrocarbon solid polymer decomposed.

It is no load or only a relatively low load F2 of 1.5 kPa or less that is applied to the electrode-membrane assembly 12 in its preliminarily dried state.

Accordingly, the electrolyte membrane 24, negative electrode layer 23 and positive electrode layer 25 are freely movable when they expand as a result of the arrival at the electrolyte membrane 24 of the vapor sprayed from the nozzles 47a and 48a.

Under no load or only a limited load F2 of 1.5 kPa or less as stated, the absorption of expansion of the electrolyte membrane 24, negative electrode layer 23 and positive electrode layer 25 prevents the separation or cracking of the electrolyte membrane 24, negative electrode layer 23 and positive electrode layer 25.

The solvent 41, such as N-methyl-2-pyrrolidone, dimethylacetamide, dimethyl sulfoxide, N,N-dimethylformamide or γ-butyrolactone, has a boiling point which is higher than that of water.

However, the solvent 41 in the electrolyte membrane 24 can be removed properly by the vapor introduced into the electrolyte membrane 24. Therefore, N-methyl-2-pyrrolidone, dimethylacetamide, dimethyl sulfoxide, N,N-dimethylformamide or γ-butyrolactone is easy to use as the solvent 41 for the electrolyte membrane 24.

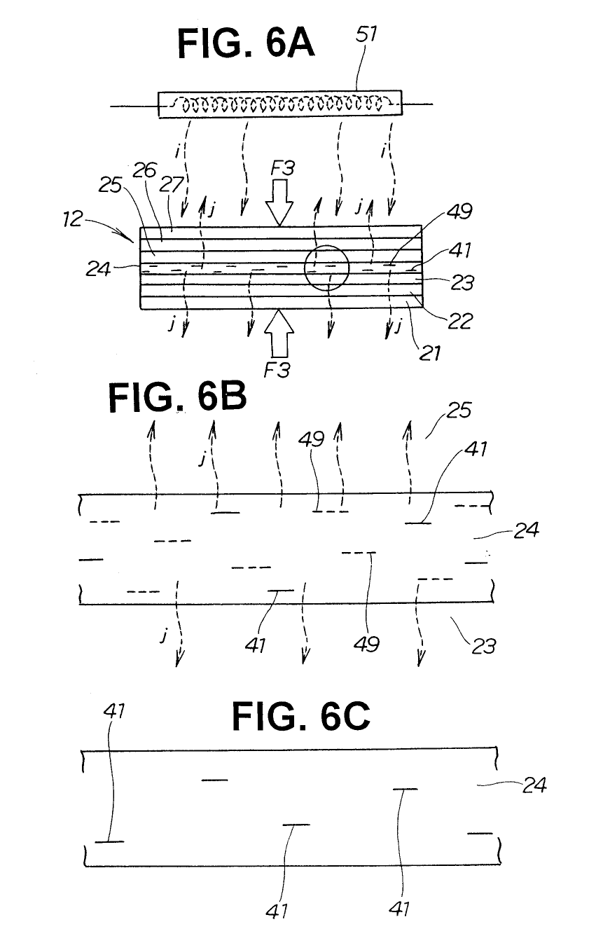

FIGS. 6A, 6B and 6C show an example in which the electrode-membrane assembly is finally dried.

In FIG. 6A, a load F3 is applied to the electrode-membrane assembly 12 in its preliminarily dried state and it is heated by a heater 51 as shown by arrows i. Its drying temperature is set at a temperature not exceeding the decomposition temperature of the hydrocarbon solid polymer. Its heating temperature is also lower than the boiling point of the solvent 41. More specifically, the decomposition temperature of the hydrocarbon solid polymer is from 160° C. to 200° C. and the drying temperature is from 50° C. to 150° C.

The heating of the electrode-membrane assembly 12 in its preliminarily dried state by the heater 51 accomplishes its final drying.

In FIG. 6B, the final drying of the electrode-membrane assembly 12 in its preliminarily dried state causes the water 49 in the electrolyte membrane 24 to evaporate as shown by arrows j.

The water 49 remaining in the electrolyte membrane 24 is removed, as shown in FIG. 6C.

Nearly all of the solvent 41 remaining in the electrolyte membrane 24 has already been removed from the electrolyte membrane 24, as explained with reference to FIG. 5B. Accordingly, the removal of water 49 from the electrolyte membrane 24 leaves only a small amount of solvent 41 in the hydrocarbon solid polymer of the electrolyte membrane 24. Thus, the carrying out of the production method shown in FIGS. 3A to 6C makes it possible to reduce the solvent 41 in the electrolyte membrane 24 drastically even if its drying temperature may be set at a temperature not exceeding the decomposition temperature of the hydrocarbon solid polymer, or a temperature lower than the boiling point of the solvent 41.

The electrode-membrane assembly 12 in its preliminarily dried state is held under no load, or a relatively low load F1 of 1.5 kPa or less.

Accordingly, the electrolyte membrane 24, negative electrode layer 23 and positive electrode layer 25 are freely movable when they contract as a result of the evaporation of a part of the solvent from the electrode-membrane assembly 12 in its preliminarily dried state as shown by the arrows c.

Under no load or only a limited load F1 of 1.5 kPa or less as stated, the absorption of contraction of the electrolyte membrane 24, negative electrode layer 23 and positive electrode layer 25 prevents the separation or cracking of the electrolyte membrane 24, negative electrode layer 23 and positive electrode layer 25.

According to the method of the present invention for producing an electrode-membrane assembly, the electrode-membrane assembly 12 in its preliminarily dried state is placed in vapor, vapor is introduced into the electrolyte membrane 24 and the solvent 41 is removed from the electrolyte membrane 24 by the vapor introduced thereinto, as described above.

Generally, a gas is composed of molecules occurring individually, but a liquid is composed of molecules gathering in a several tens of to several thousand times larger volume and has an apparent particle diameter which is drastically larger than that of a gas.

As the water-repelling treatment of the positive and negative electrode diffusion layers 21 and 27 makes the pores of the positive and negative electrode diffusion layers 21 and 27 larger in diameter than gases, but smaller than liquids, the positive and negative electrode diffusion layers 21 and 27 prevent the permeation of water in a liquid state, but do not prevent the permeation of water vapor, as stated before.

Thus, when vapor is used for the removal of the solvent 41, vapor permeates satisfactorily through the positive and negative electrode diffusion layers 21 and 27 and is introduced into the electrolyte membrane 24.

The introduction of vapor into the electrolyte membrane 24 makes it possible to remove the solvent 41 from the electrolyte membrane 24 smoothly with vapor and thereby achieve an elevated power generating performance, while maintaining productivity.

Some solvents 41 have a boiling point which is lower than the decomposition temperature of 160° C. to 200° C. of the hydrocarbon solid polymer, like DMF (N,N-dimethylformamide) having a boiling point of 153° C., as stated before.

This solvent 41 can be removed from the electrolyte membrane 24 relatively well without employing water vapor treatment as shown in FIGS. 3A to 6C, if the heating temperature for preliminary or final drying is raised to the boiling point of the solvent 41.

It is, however, difficult to remove the solvent 41 from the electrolyte membrane 24 thoroughly merely by raising the heating temperature to the boiling point of the solvent 41 without employing water vapor treatment as shown in FIGS. 3A to 6C.

Therefore, water vapor treatment as shown in FIGS. 3A to 6C is employed even in the case of using a solvent 41 having a lower boiling point than the decomposition temperature of 160° C. to 200° C. of the hydrocarbon solid polymer, so that it may be possible to remove the solvent 41 from the electrolyte membrane 24 smoothly and thereby achieve an elevated power generating performance, while maintaining productivity.

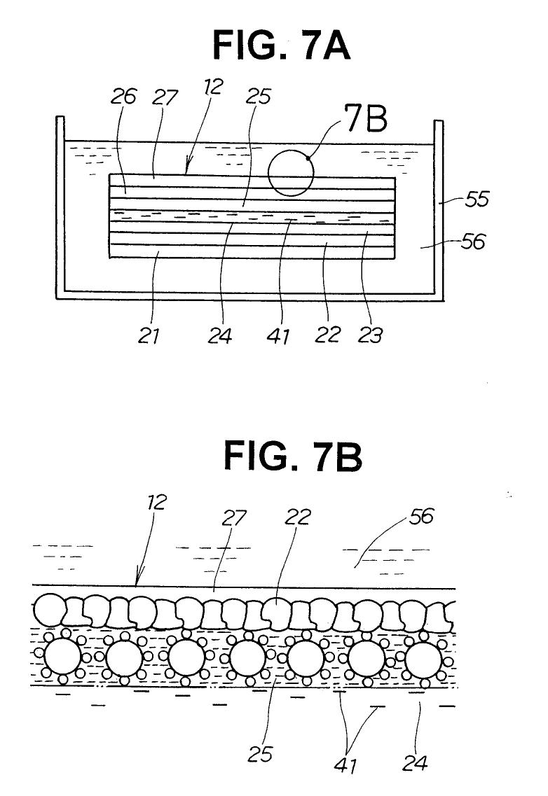

FIGS. 7A and 7B show a comparative example in which an electrode-membrane assembly is immersed in water to have a solvent removed from its electrolyte membrane.

In FIG. 7A, a preliminarily dried electrode-membrane assembly 12 is placed in a water tank 55 and immersed in water 56.

As the negative electrode diffusion layer 21 and the positive electrode diffusion layer 27 in the electrode-membrane assembly 12 have water repellency, water 56 in the liquid state is repelled by their surfaces and cannot pass through the negative electrode diffusion layer 21 or the positive electrode diffusion layer 27.

In FIG. 7B, as the negative electrode diffusion layer 21 and the positive electrode diffusion layer 27 (see FIG. 7A for the negative electrode diffusion layer 21) shut off water 56 in the liquid state, it takes a long time for the water 56 in the liquid state to pass through the negative electrode diffusion layer 21 and the positive electrode diffusion layer 27 into the electrolyte membrane 24.

According to the comparative example, therefore, it takes a long time to remove the solvent 41 from the electrolyte membrane 24 and it is difficult to remove the solvent 41 thoroughly.

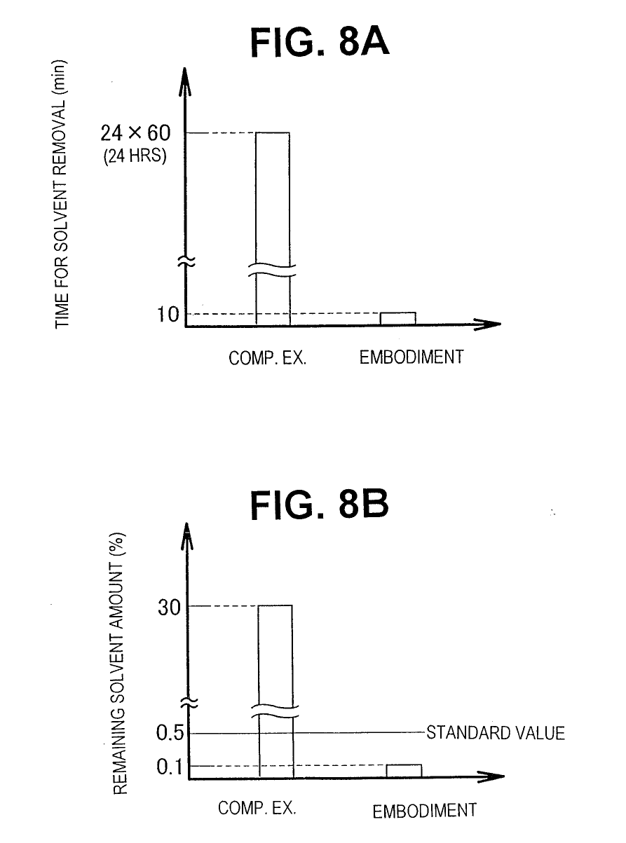

FIGS. 8A and 8B are graphs showing the amount of the solvent remaining in the electrolyte membrane.

Comparative Example refers to the example in which the solvent 41 is removed from the electrolyte membrane 24 by the method according to FIGS. 7A and 7B, and Example of the present invention refers to the example in which the solvent 41 is removed from the electrolyte membrane 24 by the method according to FIGS. 3A to 6C. The vertical axis of the graph shown in FIG. 8A refers to the time required for the removal of the solvent 41 and the vertical axis of the graph shown in FIG. 8B refers to the amount of the solvent 41 remaining in the electrolyte membrane 24.

In view of the productivity of the electrode-membrane assembly 12, it is preferable to limit the time required for the removal of the solvent 41 to 60 minutes or less. In view of the power generating performance of the electrode-membrane assembly 12, on the other hand, it is preferable to limit the remaining amount of the solvent 41 to 0.5% or less. Accordingly, the cases in which the time required for the removal of the solvent 41 is 60 minutes or less and the remaining amount of the solvent 41 is 0.5% or less were evaluated as “Good”, and any other cases were evaluated as “Bad”.

The remaining amount of the solvent 41 was shown on a weight basis relative to the weight of the polymer in the electrolyte membrane 24 taken as 100%.

A preliminarily dried electrode-membrane assembly 12 was immersed in water for 24 hours according to the Comparative Example, and was exposed to vapor for 10 minutes according to the Example of the present invention, as shown by the graph in FIG. 8A.

The amount of the solvent 41 remaining in the electrolyte membrane 24 was 30% according to the Comparative Example, and 0.1% according to the Example of the present invention. The remaining amount of the solvent according to the Comparative Example was 20 to 30%, but the graph in FIG. 8B shows it simply as 30%.

The Comparative Example teaches that the amount of the solvent 41 remaining in the electrolyte membrane 24 is as much as 30% even after a long time of immersion of the preliminarily dried electrode-membrane assembly 12 in water. Thus, the Comparative Example is evaluated as “Bad”, insofar as the time required for the removal of the solvent 41 exceeded 60 minutes and the remaining amount of the solvent 41 was over 0.5%.

On the other hand, the Example of the present invention teaches that the amount of the solvent 41 remaining in the electrolyte membrane 24 can be reduced to 0.1% merely by a short time of exposure of the preliminarily dried electrode-membrane assembly 12 to vapor. Thus, the Example of the present invention is evaluated as “Good”, since the time required for the removal of the solvent 41 was not longer than 60 minutes and the remaining amount of the solvent 41 was less than 0.5%.

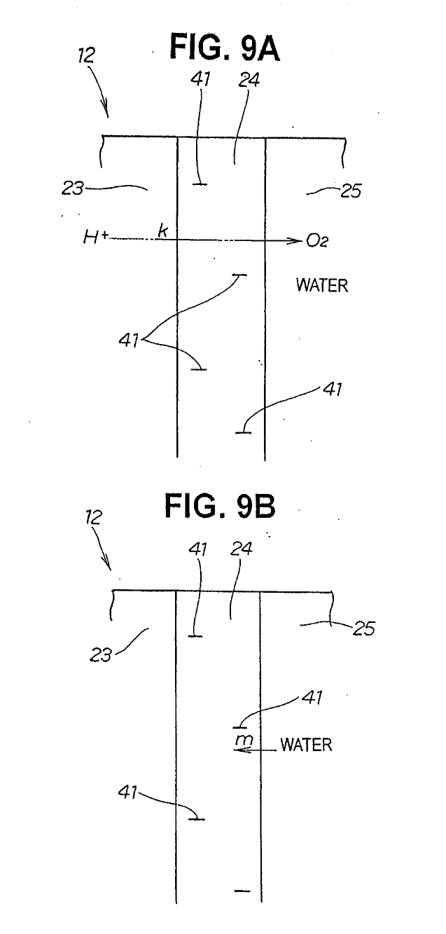

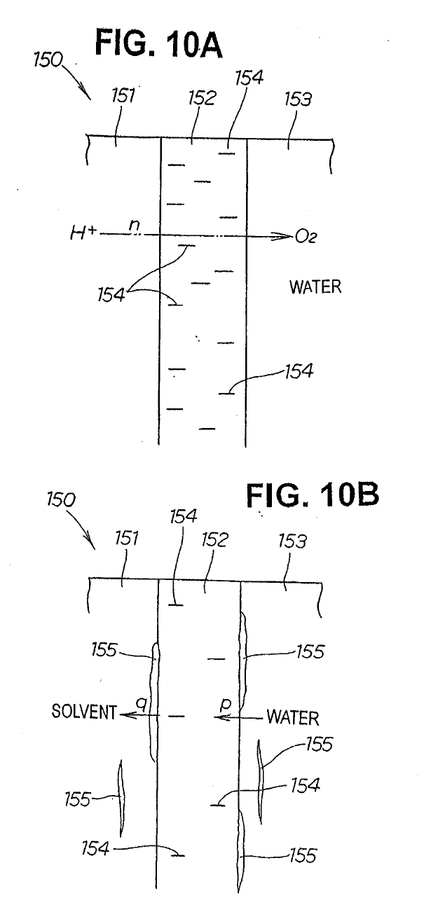

An Example of the present invention and a Comparative Example in which an electrode-membrane assembly 12 is employed as a fuel cell will now be described based on FIGS. 9A and 9B and FIGS. 10A and 10B.

FIGS. 9A and 9B show an example in which an electrode-membrane assembly according to the Example of the present invention is employed.

A hydrogen ion (H⁺) in a negative electrode layer 23 passes through an electrolyte membrane 24 and flows into a positive electrode layer 25, as shown by an arrow k in FIG. 9A. The hydrogen ion (H⁺) reacts with oxygen (O₂) in the positive electrode layer 25 to generate water (H₂O).

A part of the water (H₂O) generated in the positive electrode layer 25 is introduced from the positive electrode layer 25 into the electrolyte membrane 24 as shown by an arrow m in FIG. 9B.

The introduction of a part of the generated water into the electrolyte membrane 24 keeps the electrolyte membrane 24 in a moist state. The keeping of the electrolyte membrane 24 in a moist state maintains the power generating performance of the electrode-membrane assembly 12.

It is possible that the introduction of a part of the generated water into the electrolyte membrane 24 may cause the solvent 41 remaining in the electrolyte membrane 24 to flow out from the electrolyte membrane 24. The outflow of a large amount of solvent 41 from the electrolyte membrane 24 is likely to bring about a big dimensional change in the electrolyte membrane 24 and thereby cause the separation or cracking of the electrolyte membrane 24.

According to the present invention, therefore, the solvent 41 remaining in the electrolyte membrane 24 of the electrode-membrane assembly 12 is limited to as little as 0.5%, as explained with reference to FIG. 8B.

The limitation of the solvent 41 remaining in the electrolyte membrane 24 to as little as 0.5% makes it possible to prevent any large dimensional change from occurring to the electrolyte membrane 24 even if the solvent 41 may flow out from the electrolyte membrane 24. This makes it possible to prevent any separation or cracking from occurring in the electrode-membrane assembly 12 and thereby maintain the power generating performance of the electrode-membrane assembly 12.

FIGS. 10A and 10B show an example in which an electrode-membrane assembly according to the Comparative Example is employed.

The electrode-membrane assembly 150 according to the Comparative Example has a solvent 154 removed from its electrolyte membrane 152 by immersion in water 56 in the water tank 55 as explained with reference to FIGS. 7A and 7B. As much as 30% of solvent 154 remains in the electrolyte membrane 152, as explained with reference to FIG. 8B.

A hydrogen ion (H⁺) in a negative electrode layer 151 forming the electrode-membrane assembly 150 passes through the electrolyte membrane 152 and flows into a positive electrode layer 153, as shown by an arrow n in FIG. 10A. The hydrogen ion (H⁺) reacts with oxygen (O₂) in the positive electrode layer 153 to generate water (H₂O).

A part of the water (H₂O) generated in the positive electrode layer 153 is introduced from the positive electrode layer 153 into the electrolyte membrane 152 as shown in FIG. 10B. The introduction of a part of the generated water into the electrolyte membrane 152 keeps the electrolyte membrane 152 in a moist state. The keeping of the electrolyte membrane 152 in a moist state maintains the power generating performance of the electrode-membrane assembly 150.

However, the introduction of a part of the generated water from the positive electrode layer 153 into the electrolyte membrane 152 causes a large amount of solvent 154 to flow out from the electrolyte membrane 152, since as much as 30% of solvent 154 remains in the electrolyte membrane 154 of the electrode-membrane assembly 150.

It is possible that the outflow of a large amount of solvent 154 from the electrolyte membrane 152 may cause a big dimensional change in the electrolyte membrane 152.

If a big dimensional change occurs to the electrolyte membrane 152, the electrolyte membrane 152 tends to shift relative to the negative electrode layer 151 and the positive electrode layer 153. As a result, a shearing force is generated in the boundary between the electrolyte membrane 152 and the negative electrode layer 151 and a shearing force is generated in the negative electrode layer 151, too. At the same time, a shearing force is generated in the boundary between the electrolyte membrane 152 and the positive electrode layer 153 and a shearing force is generated in the positive electrode layer 153, too.

It is, therefore, possible that separation or cracking 155 may occur in the electrode-membrane assembly 150. This is likely to lower the power generating performance of the electrode-membrane assembly 150.

Although the present invention has been described by reference to the case in which the electrode-membrane assembly 12 is made by superposing the negative electrode diffusion layer 21, negative electrode substrate layer 22, negative electrode layer 23, electrolyte membrane 24, positive electrode layer 25, positive electrode substrate layer 26 and positive electrode diffusion layer 27 on one another in their order, it is also possible to make the electrode-membrane assembly 12 by superposing the positive electrode diffusion layer 27, positive electrode substrate layer 26, positive electrode layer 25, electrolyte membrane 24, negative electrode layer 23, negative electrode substrate layer 22 and negative electrode diffusion layer 21 on one another in their order.

Although the present invention has been described by reference to the case in which at least one of NMP, DMAc, DMSO, DMF and γ-butyrolactone is selected as the solvent 41, it is not limited to NMP, DMAc, DMSO, DMF and γ-butyrolactone.

Although the present invention has been described by reference to the case in which water vapor is employed as vapor, it is also possible to employ any alcohol or other vapor not damaging the electrolyte membrane 24.

Although the present invention has been described by reference to the case in which the electrode-membrane assembly 12 in its non-dry state is preliminarily dried by the heater 45 and the electrode-membrane assembly 12 in its preliminarily dried state is finally dried by the heater 51, it is also possible to employ warm air or other means instead of the heaters 45 and 51 for the preliminary and final drying of the electrode-membrane assembly 12.

Although the present invention has been described by reference to the case in which when a load applied to the electrode-membrane assembly 12 on the occasion of the preliminary drying of the electrode-membrane assembly 12 is F1, a load applied to the electrode-membrane assembly 12 on the occasion of the removal of the solvent 41 from the electrolyte membrane 24 with vapor is F2 and a load applied to the electrode-membrane assembly 12 on the occasion of the final drying of the electrode-membrane assembly 12 is F3, such treatment is performed under no load, or by employing a load of 1.5 kPa or less as each of F1, F2 and F3, the application of a certain load F1, F2 or F3 to the electrode-membrane assembly 12 is preferable to no load to ensure better adherence in the electrode-membrane assembly 12.

### INDUSTRIAL APPLICABILITY

The present invention is suitable as a method of producing an electrode-membrane assembly for a fuel cell including an electrolyte membrane of a hydrocarbon solid polymer.

1. A method of producing an electrode-membrane assembly for a fuel cell by coating one of positive and negative electrode diffusion layers with a substrate layer, coating the substrate layer with one of positive and negative electrode layers before the drying of the substrate layer, coating the electrode layer with a hydrocarbon solid polymer with a solvent added thereto before the drying of the electrode layer to form an electrolyte membrane, coating the electrolyte membrane with the other of the positive and negative electrode layers before the drying of the electrolyte membrane and superposing on the other electrode layer before the drying of the other electrode layer a two-layer body formed by coating the other of the positive and negative electrode diffusion layers with a substrate layer to produce an electrode-membrane assembly, said method comprising the steps of.
drying preliminarily the electrode-membrane assembly in its non-dry state at a temperature not exceeding the decomposition temperature of the hydrocarbon solid polymer;
placing the preliminarily dried electrode-membrane assembly in vapor to introduce vapor into the electrolyte membrane;
removing the solvent from the electrolyte membrane with the vapor introduced thereunto; and
drying finally the electrode-membrane assembly having the solvent removed from the electrolyte membrane at a temperature not exceeding the decomposition temperature of the hydrocarbon solid polymer.

2. The method of claim 1, wherein the removing of the solvent from the electrolyte membrane is performed at a temperature not exceeding the decomposition temperature of the hydrocarbon solid polymer.

3. The method of claim 1, wherein the electrode-membrane assembly in its non-dry state is held under no load, or a load of 1.5 kPa or less when the solvent is removed from the electrolyte membrane, and the electrode-membrane assembly having the solvent removed from its electrolyte membrane is held under no load, or a load of 1.5 kPa or less when the electrode-membrane assembly is finally dried.

4. The method of claim 1, wherein the solvent is at least one selected from N-methyl-2-pyrrolidone, dimethylacetamide, dimethyl sulfoxide, N,N-dimethylformamide and γ-butyrolactone.

5. The method of claim 2, wherein the electrode-membrane assembly in its non-dry state is held under no load, or a load of 1.5 kPa or less when the solvent is removed from the electrolyte membrane, and the electrode-membrane assembly having the solvent removed from its electrolyte membrane is held under no load, or a load of 1.5 kPa or less when the electrode-membrane assembly is finally dried.

6. The method of claim 2, wherein the solvent is at least one selected from N-methyl-2-pyrrolidone, dimethylacetamide, dimethyl sulfoxide, N,N-dimethylformamide and γ-butyrolactone.

7. The method of claim 3, wherein the solvent is at least one selected from N-methyl-2-pyrrolidone, dimethylacetamide, dimethyl sulfoxide, N,N-dimethylformamide and γ-butyrolactone.

8. The method of claim 5, wherein the solvent is at least one selected from N-methyl-2-pyrrolidone, dimethylacetamide, dimethyl sulfoxide, N,N-dimethylformamide and γ-butyrolactone.
